(19) United States
(12) Patent Application Publication
(10) Pub. No.: US 2017/0324834 A1
(43) Pub. Date: Nov. 9, 2017

(54) SYSTEM AND METHOD FOR GENERATING AND TRANSMITTING A NON-REAL TIME COMMUNICATION

(71) Applicant: GLOBAL TEL*LINK CORP., Reston, VA (US)

(72) Inventor: Stephen L. HODGE, Aubrey, TX (US)

(21) Appl. No.: 15/148,014

(22) Filed: May 6, 2016

(51) Int. Cl. H04L 29/08; H04L 12/825; H04L 12/28; H04L 12/26; H04L 12/911

(52) U.S. Cl. CPC H04L 67/325; H04L 47/826; H04L 47/822; H04L 12/287; H04L 43/0876; H04L 47/25

(57) ABSTRACT

A system and method for generating and transmitting a non-real time communication are disclosed. The system includes a communication center having a communication server and a scheduling server which reduce a cost of transmitting non-real time communications. The communication server controls at least one or more of a transmission speed, a transmission quality, or a transmission packet size. The scheduling server is configured to schedule the transmission of non-real time communications based on when network traffic is low or near idle.

### BACKGROUND

### Field

The disclosure relates to a communication system that facilitates non-real time communications transmissions to/from a correctional facility.

### Background

Correctional facilities provide inmates with the ability to communicate with friends, families, and visitors as it improves recidivism and provides incentives for inmates to follow rules and policies of the facility. In addition to traditional telephone calls and telephone visitations, correctional facilities seek to offer a wide variety of communication services to inmates, such as video visitation and video calls, among others. As the amount of communication options available to inmates increases, an amount of network availability space decreases, especially during peak hours of a day.

### BRIEF DESCRIPTION OF THE DRAWINGS/FIGURES

The accompanying drawings, which are incorporated herein and form a part of the specification, illustrate embodiments of the present disclosure and, together with the description, further serve to explain the principles of the disclosure and to enable a person skilled in the pertinent art to make and use the embodiments.

FIG. 1 illustrates a block diagram of a communication system, according to exemplary embodiments of the present disclosure;

FIG. 2 illustrates a block diagram of a communication center, according to exemplary embodiments of the present disclosure;

FIG. 3 illustrates an application server, according to exemplary embodiments of the present disclosure;

FIG. 4 illustrates a flowchart diagram of a method for generating a non-real time communication, according to exemplary embodiments of the present disclosure:

FIG. 5 illustrates a flowchart diagram of a method for transmitting a non-real time communication, according to exemplary embodiments of the present disclosure; and

FIG. 6 illustrates a computer system, according to exemplary embodiments of the present disclosure.

The present disclosure will be described with reference to the accompanying drawings. In the drawings, like reference numbers indicate identical or functionally similar elements. Additionally, the left most digit(s) of a reference number identifies the drawing in which the reference number first appears.

### DETAILED DESCRIPTION

The following Detailed Description refers to accompanying drawings to illustrate exemplary embodiments consistent with the disclosure. References in the Detailed Description to “one exemplary embodiment,” “an exemplary embodiment,” “an example exemplary embodiment,” etc., indicate that the exemplary embodiment described may include a particular feature, structure, or characteristic, but every exemplary embodiment may not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to affect such feature, structure, or characteristic in connection with other exemplary embodiments whether or not explicitly described.

The exemplary embodiments described herein are provided for illustrative purposes, and are not limiting. Other exemplary embodiments are possible, and modifications may be made to the exemplary embodiments within the spirit and scope of the disclosure. Therefore, the Detailed Description is not meant to limit the invention. Rather, the scope of the invention is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc. Further, any of the implementation variations may be carried out by a general purpose computer, as described below.

For purposes of this discussion, any reference to the term “module” shall be understood to include at least one of software, firmware, and hardware (such as one or more circuit, microchip, or device, or any combination thereof), and any combination thereof. In addition, it will be understood that each module may include one, or more than one, component within an actual device, and each component that forms a part of the described module may function either cooperatively or independently of any other component forming a part of the module. Conversely, multiple modules described herein may represent a single component within an actual device. Further, components within a module may be in a single device or distributed among multiple devices in a wired or wireless manner.

The following Detailed Description of the exemplary embodiments will so fully reveal the general nature of the invention that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

### Overview

Communication between inmates and outsiders has been shown to be an extremely important part of rehabilitation. Allowing for an inmate to keep in contact with friends and family significantly helps to reduce recidivism as well as to prepare an inmate for life after prison. Because most inmates are eventually released back into the public, any steps to minimize problems with their re-assimilation with society are highly beneficial.

Traditionally communications between inmates and outsiders only included telephone calling and letter writing. However, over the years newer technologies such as email, texting, and video calling have been used by correctional facilities. While these newer technologies provide the ability for inmates to communicate with others in modern ways, the newer technologies create network issues which may cause network bottlenecking and broadband speed limitations.

In particular, as devices, such as smart devices, have become more prevalent both inside and outside of correctional facilities, the demand for network space and speed has increased. The increased use of network bandwidth drives the cost of the bandwidth up, especially during peak network times, such as 6:00 PM to 10:00 PM.

In light of the above, the present disclosure provides a system and method for non-real time communications in a correctional facility by facilitating a delayed messaging system such as a delayed video, audio, image, and/or text messages. The non-real time communications can be single or bundled type communications that are delivered at a scheduled time. The present disclosure provides a system and method for inmates and outsiders to save on communication costs by allowing the non-real time communication to be transmitted during off-peak network times, such as 1:00 AM to 6:00 AM, and/or a reduced transmission speed.

### Communication System

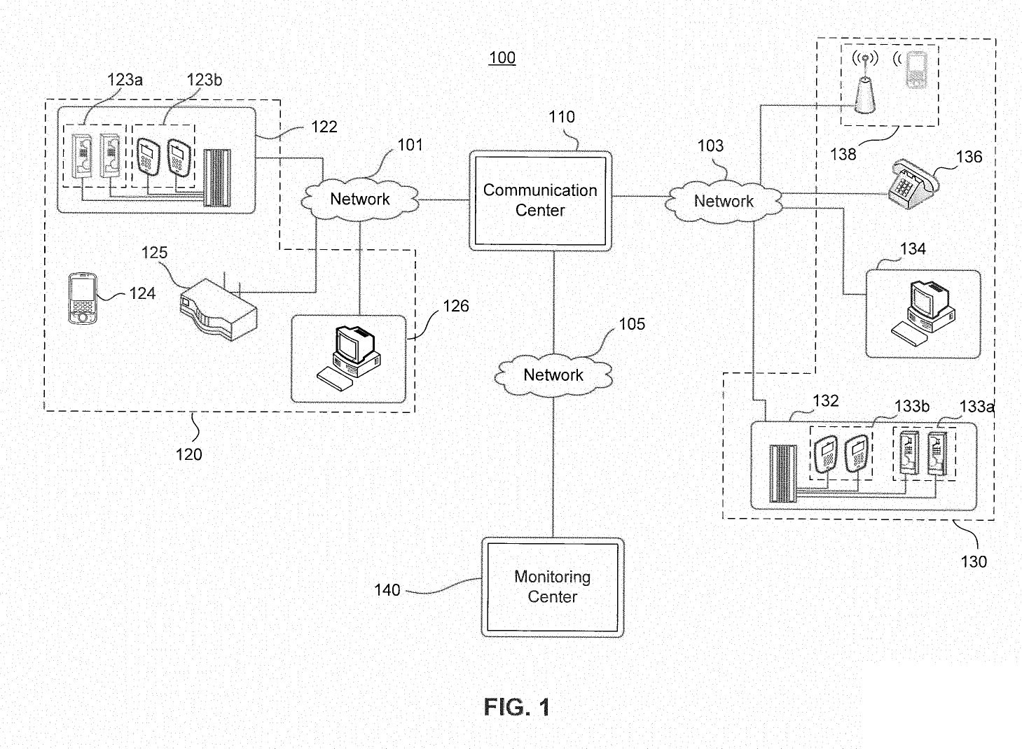

FIG. 1 illustrates a block diagram of a communication system 100, according to exemplary embodiments of the present disclosure. The communication system 100 includes a communication center 110 configured to receive and transmit non-real time communication between an inmate communication device 120 and an outsider communication device 130. In this disclosure, a non-real time communication refers to a delayed communication between two parties, in particular, an audio, video, image, or text communication between an inmate using the inmate communication device 120 and an outsider using the outsider communication device 130. Non-real time data refers to the non-real time communication and/or data related to the communication and the parties, as will be described in further detail below.

The inmate communication device 120 includes any or all devices such as wired communication devices 122, which include audio communication devices 123a and video communications devices 123b, wireless communication device 125, and/or a control station 126. The communication center 120 also connects to a wireless access point 125 (e.g., a router), which may provide connectivity to the wireless devices 124. The inmate communication devices 120, such as the video communications devices 123b, the wireless communication device 125, and/or the control station 126, are configured to include a camera and a screen for generating and viewing videos or images. The inmate communication device 120 connects to the communication center 110 via a network 101. The network 101 includes a Local-Area Network (LAN), a Wide-Area Network (WAN), or the Internet, depending on the locations of the communication center. For example, the communication center 110 may be located at a correctional facility where the inmate communication device 120 is located and therefore a LAN is used. In another example, the communication center 110 is located at a different location than the correctional facility and therefore the network 101 is a WAN or the Internet.

The outsider communication device 130 includes any and all devices such as wired communication devices 132, which include audio communication devices 133a and video communications devices 133b, a work station 134, a basic telephone 136, and/or a wireless communication device 138. The outsider communication devices 130, such as the video communications devices 133b, the wireless communication device 138, and/or the work station 134, are configured to include a camera and a video screen for generating and viewing a video. The outsider communication device 130 connects to the communication center 110 via network 103, which may include any or all of a WAN, the Internet, and/or a Public Switched Telephone Network (PSTN). The WAN may facilitate communications with other nearby prisons, such as those within the same county, state, etc. Wired audio and/or video communication devices 132 located at those other facilities may provide cross-facility visitations between inmates. In an embodiment, WebRTC may be utilized in place of a session initiation protocol (SIP) over a WAN or the Internet, each of which provides a dedicated, private link between the inmate communication device 120 and the outsider communication device 130. The Internet is utilized to provide access to the remote station 134 such as remotely distributed control stations, scheduling clients, and home visitation devices. The PSTN can be used to provide connectivity to the basic telephone 136 and/or the wireless communication device 138 and other communication devices (not shown) over traditional data networks.

The communication system 100 also includes a monitoring center 140 configured to receive non-real time communications and data from the communication center 110. The monitoring center 140 can receive non-real time communications and data so as to facilitate the monitoring of the non-real time communications both automatically and manually by a reviewer. The monitoring center 140 may further be configured to communicate with the communication center 110 to indicate approval of starting, sending, or receiving the non-real time communications after an initial monitoring verification has been performed.

### Communication Center

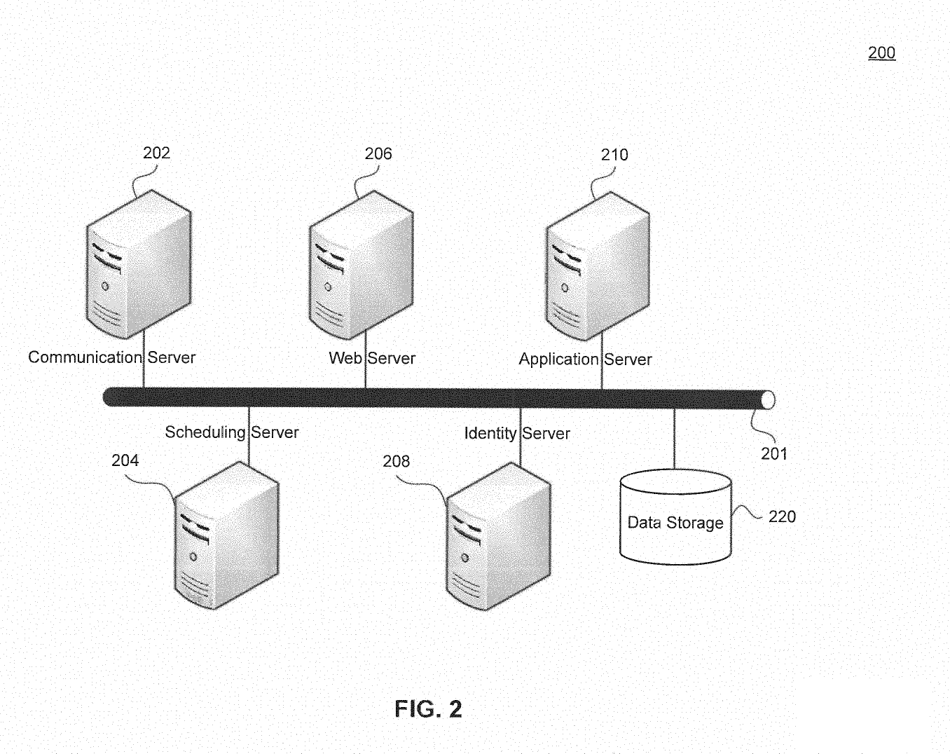

FIG. 2 illustrates a block diagram of a communication center 200, according to exemplary embodiments of the present disclosure. The communication center 200 may represent an exemplary embodiment of the communication center 110 of FIG. 1. The communication center 200 includes a communication server 202, a scheduling server 204, web server 206, an application server 210, and data storage 220, that are all connected to each other via a network bus 201.

Each of the servers 202-210 can be constructed as individual physical hardware devices, or as virtual servers. The number of physical hardware machines can be scaled to match the number of simultaneous user connections desired to be supported in the communication system 100.

The communication server 202 consists of any number of servers, and is configured to receive and transmit non-real time communications and data. The communication server 202 supports non-real time communications between inmates using the inmate communication device 120 and outsiders using the outsider communication device 130. The communication server 202 is configured to control how non-real time communications are transmitted. In doing so, the communication server 202 performs switching required to electrically connect to a party, when receiving non-real time communications and data, and connect to another party, when transmitting the non-real time communications. Further, the communication server 202 controls a network governor to adjust a transmission speed, encoding/decoding circuitry to adjust quality and a compression rate, and/or packet circuitry to adjust a size of non-real time communication packets. The communication server 202 is also configured to store non-real time communications and data. The communication server 202 stores non-real time communications and data as files on an internal storage or an external storage, as will be explained in more detail below. The communication server 202 is further configured to transmit non-real time communication and data to the monitoring center 140.

Because there may be a variety of different communication standards employed by different audio, video, image, and text devices that wish to participate in non-real time communications, in an embodiment, the communication server 202 may also perform format conversion of the non-real time communications and data. The conversion my convert incoming communications as needed, or may convert outgoing communications to be compatible with the inmate communication device 120, the outsider communication device 130, or the monitoring center 140. For example, an inmate can generate an audio communication using the audio communication device 123a, and an outsider can listen to the audio communication by way of one of the basic telephone 136 or the wireless communication device 138.

Further, because the communication server 202 receives and transmits non-real time communications and data by way of a network, in an exemplary embodiment, the communication server 202 can decrypt received non-real time communications and data and encrypt non-real time communications and data prior to transmitting the non-real time communications and data, for security purposes.

The scheduling server 204 consists of any number of servers, and is configured to gather and generate data to determine a cost and a schedule for transmitting non-real time communications to one of the parties. The scheduling server 204 receives and stores a multitude of cost factors used to determine available cost options for a transmitting party. The cost factors includes one or more of size and type of data, location of parties, date and time of transmissions, speed of transmission, transport and routing fees from carriers, predicted amount of traffic on the network at predetermined times, or jurisdictional and facility fees. Additionally, the scheduling server 204 receives and stores a multitude of scheduling factors used to determine a schedule for transmitting the non-real time communication. The scheduling factors include one or more of a cost factor, instructions from a transmitting party, desired date and time of transmission by the transmitting party, desired date and time of reception by a receiving party, desired speed of transmission, available carriers to transmit the communication, and jurisdictional and facility regulations. Some or all of the cost and scheduling factors can be stored internally to the scheduling server 204 or on external storage, as will be explained in more detail below. In an embodiment, the scheduling server 204 can determine an time to transmit the non-real time communication that is at a lowest cost for a transmitting party based on the cost and scheduling factors. For example, the scheduling server 204 determines a lowest cost based on when the network is predicted to be idle (e.g., between 1 am and 6 am) and based on a communication being transmitted at a slow transmission speed. As another example, the scheduling server 204 determines a lowest cost based on the lowest cost of transmitting the non-real time communication during a predetermined time period such as a 24 hour period.

The web server 206 consists of any number of servers, and is configured to run web server software such as Apache and/or Microsoft Internet Information Server and/or an interactive voice response (IVR) server software. The primary function of the web server 206 is to route requests and other communications from inmate communication device 120 or the outsider communication device 130 to an appropriate destination within the non-real time communication system 100. In an embodiment, the web server 206 can also serve as a maintenance point into the communication center 200, by which servicing, configuring, and updating can be performed. In an embodiment, the web server 206 is connected to both the public Internet and the internal network of the facility. In an embodiment, the web server 206 can provide managing services for generating non-real time communications, receiving instructions from a party to send or receive non-real time communications, and coordinating the transmission of non-real time communications. For example, the web server 206 can facilitate a party in generating a non-real time communication when the party uses a front-end application having a user interface.

The identity server 208 consists of any number of servers, and is configured to collect and store identity data of inmates and outsiders using the communication system 100. Identity data includes at least one of password data, voice data, fingerprint data, facial data (2D or 3D), device data such as make and model of a communication device, or location data. The identity server 208 is further configured to facilitate a secure communication between parties receiving/transmitting a communication by performing identity verifications such as logon verifications such as username and passwords, biometric verifications such as voice recognition, fingerprint recognition, retinal recognition, facial recognition (2D or 3D), device verification, and/or location verification.

The data storage 220 provides access to a wide variety of data such as identification of parties involved transmitting and receiving non-real time communications, scheduling data, and/or any data stored by the communication server 202, the scheduling server 204, the web server 206. Because the data stored on the data storage 220 may consume a significant amounts of storage space, the data storage 220 may include a Network Attached Storage (NAS) device, which is configured as a mass storage device. In order to reduce the required size of the data storage 220 preferably includes a backup routine to transfer data to permanent storage devices, such as archival permanent storage or optical disks, after a predetermined time has elapsed since the initial recording of that data. The data storage 220 is connected to communication server 202 and the application server 210 by way of the network bus 201.

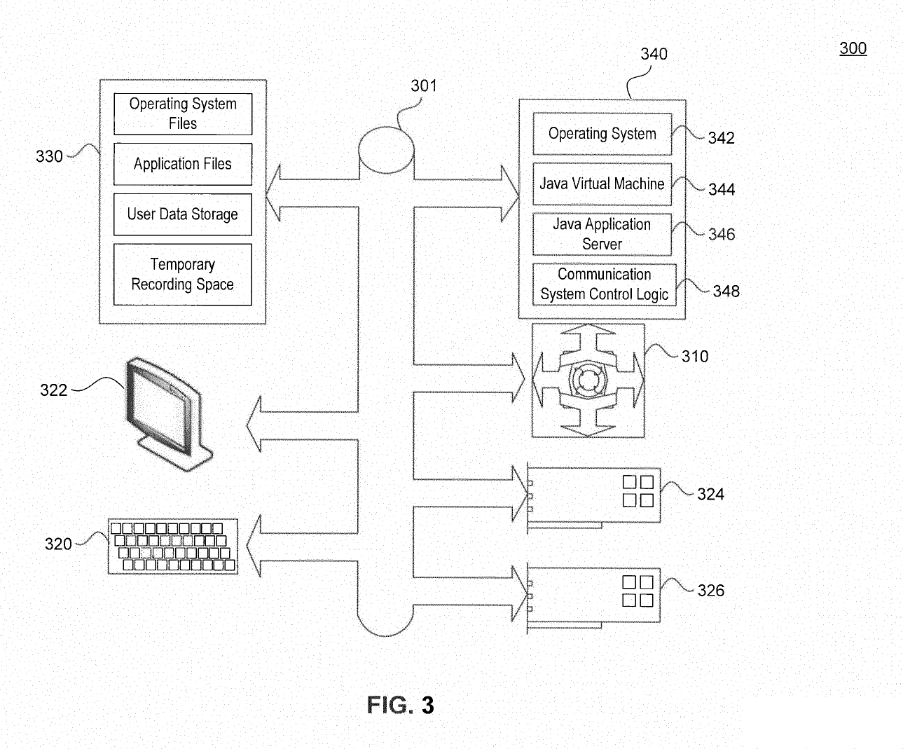

FIG. 3 illustrates an application server 300, according to exemplary embodiments of the present disclosure. The application server 300 may represent an exemplary embodiment of the application server 210 depicted in FIG. 2. The application server 300 consists of any number of servers, and functions as the primary logic processing center in the communication system 100. The application server 300 is configured to manage and facilitate communication between the communication server 202, the scheduling server 204, the web server 206, and the data storage 220.

The application server 300 includes one or more central processing units (CPU) 310 connected via a bus 301 to several other peripherals. Such peripherals include an input device, such as a keyboard and/or mouse 320, a monitor 322 for displaying information, a network interface card 324 and/or a modem 326 that provide network connectivity and communication.

The application server 300 also includes internal data storage 330. This data storage 330 is non-volatile storage, such as one or more magnetic hard disk drives (HDDs) and/or one or more solid state drives (SSDs). The data storage 330 is used to store a variety of important files, documents, or other digital information, such as the operating system files, application files, user data, and/or temporary recording space.

The application server 300 also includes system memory 340. The system memory 340 is preferably faster and more efficient than the data storage 330, and is configured as random access memory (RAM) in an embodiment. The system memory 340 contains the runtime environment of the application server, storing temporary data for any of the operating system 342, java virtual machine 344, java application server 346, and communication control logic 348.

### System Operation

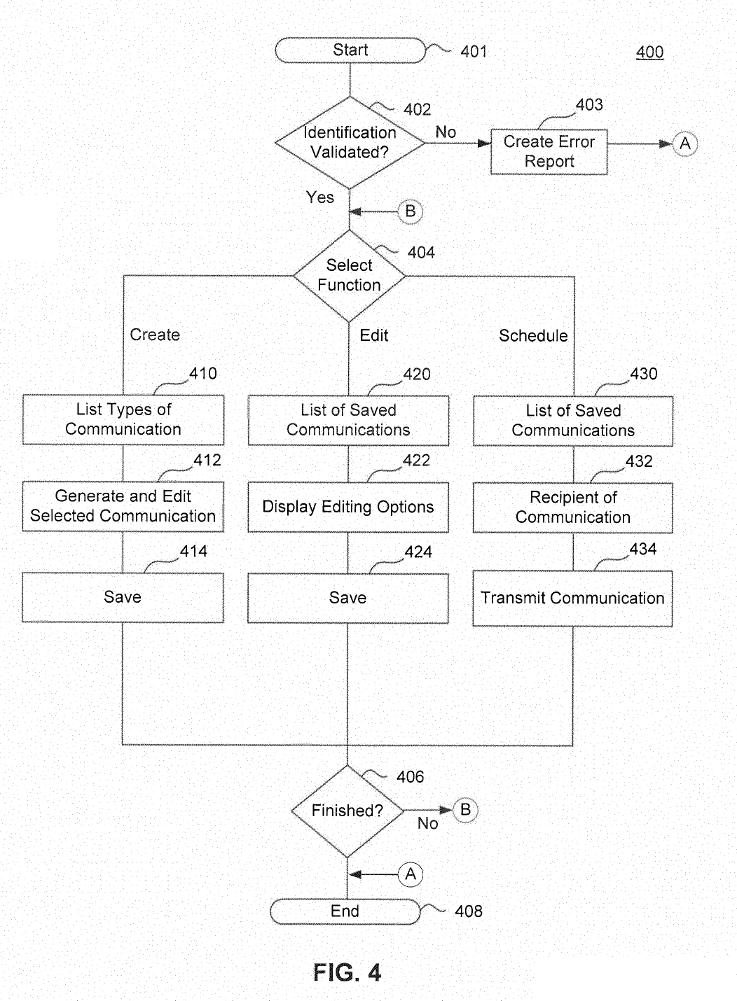

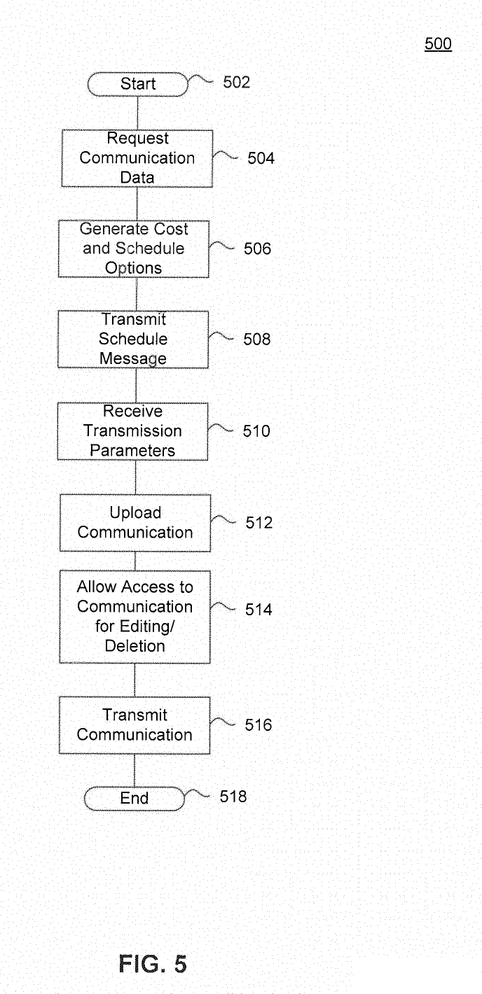

Operations of generating and transmitting a communication by the communication center 100 will be described with respect to FIGS. 4 and 5. Although the physical devices and components that form the system have largely already been described, additional details regarding their more nuanced operation will be described below with respect to FIGS. 1-3. While FIGS. 4 and 5 contain methods of operation of the communication center 100, the operations are not limited to the order described below, and various operations can be performed in a different order. Further, two or more operations of each method can be performed simultaneously with each other.

The communication system 100 provides communications between a variety of different devices. For starters, regardless of the communication type, all communications to/from an inmate communication device are transported by way of the communication center 110. In the case of traditional phones, because they are not connected directly to each other, the communication center 110 is configured to provide line power and logical switching services.

A user interface such as a website, the IVR, or another interface is managed by, or on behalf of, a correctional facility. The interface provides an interactive platform for users wanting to generate, transmit, and receive non-real time communications from/to the correctional facility. Accordingly, the interface's backend links to or communicates with the application server 210 via the web server 206.

In the following operations, examples of a website interface will be explained. However, as will be understood by those skilled in the arts, in other embodiments the interface may be the IVR which may limit some of the below operations to only the generation, transmission, and retrieval of audio communications.

### Communication Generation Operation

A communication generating operation of the communication center 100 will be described with respect to FIG. 4, which illustrates a flowchart diagram of a method 400 for generating a non-real time communication, according to exemplary embodiments of the present disclosure.

A user, either an inmate or an outsider, wishing to generate and transmit a non-real time communication must first register and set up an account with the communication center 100. The registry process requires the user to submit identity information to the communication system 100 in order to verify the user's identity to a high degree of likelihood. The identity information includes at least one of password data, voice data, facial data, fingerprint data, facial data (2D or 3D), device data such as make and model of a communication device, or location data. Registration can be either in-person or online, depending on correction facility rules. This is particularly important for security purposes, to ensure that the communication center 100 can properly vet an inmate's contacts. As with all authentication procedures described herein, upon a predetermined number of failed attempts to authenticate themselves, the user will be prohibited from accessing the communication center 110 (at least until the user can confirm their identity by some other way such as in-person, over the phone, or online confirmation, to unlock the user's account).

Once registered, an operation of generating a communication starts when an attempt to logon to the account occurs (401). An attempt to logon may occur when the user enters a username and password at the website to request the generation of a non-real time communication. Once the attempt has occurred, an identity of the user is verified by the communication center 110 (402). To verify the identity of the user, the identity server 208 can request from the user at least one of a password, a voice sample, a fingerprint scan, facial image sample (2D or 3D), device data such as make and model of the user's communication device, or location data. Once the data is received, the identity server 208 can compare the received data against stored identity data to determine the validity of the identity of the user. If the identity of the user is not verified, an error report is generated (403) which indicates to the user and/or the communication system application server 210, that the identity verification failed, and then the communication generating operation ends (408). Otherwise, the user obtains access to a user interface that allows the generation, transmission, and/or the retrieval of a non-real time application.

The user interface allows the user to select from creating, editing, scheduling to send, and/or retrieve a non-real time communication (404). As the retrieval of non-real communications may be performed by push or pull notifications and/or a simply pressing a button, further description of the retrieval of non-real communications is omitted for brevity. If the user selects to create a communication, the user interface will transition to an interface that provides the user with a list of the types of communications that can be generated (410). For example, the list can include audio, video, image, text, or bundled communications. Next, the user can begin to generate the selected type of communication and edit the communication (412). For example, if the communication device 130 contains a camera, the user can begin to generate a video communication. As another example, the user can upload a photograph, or have the camera take the photograph, and generate a communication with the photograph and text which describes the photograph. The user interface may include editing tools which facilitate editing the communication such as a cropping tool, insertion tool, a removal tool, etc. After the user is finished generating the communication, the user can save the generated communication (414). To save the communication, a title can be given to the generated communication and then the generated communication is uploaded to the communication server 202. The uploaded communication can be indexed and linked to the title for quick retrieval at a later time by a communication device 120 or 130. In an embodiment, the generated communication can be saved on the inmate communication device 120 or outsider communication device 130, if the device has the capabilities. For example for a wireless communication device 138 such as a smart phone, the generated communication can be saved on the device itself until the user indicates that it is ready to be transmitted. The user will then have the option of finishing the communication generation operation (406). If the user selects to finish, the operation ends (408). Otherwise, the user can select from creating, editing, or scheduling to send a communication (404).

When the user selects to edit a communication, the user interface displays a list of saved communications (420). Here, the user can edit a saved communication by directly changing the communication or can add additional data such as text, a photograph, etc. To facilitate editing, the user interface displays the editing tools (422). The communication center 110 allows the user to edit a saved communication until a predetermined time or event occurs.

When the user selects to send a communication, the user interface displays a list of saved communications (430). Here, the user can select a saved communication to transmit to another party. Once selected, the user interface transitions to display a request for information on the recipient of the communication (432) which the user enters identification information for the recipient. The user interface then transitions to display information and an option to transmit the selected saved communication (434), as will be described in detail below. Next, the user will have the option of being finished (406), and if determined to be finished, the communication generation operation ends (408).

### Communication Transmission Operation

A communication transmission operation of the communication center 100 will be described with respect to FIG. 5, which illustrates a flowchart diagram of a method 500 for transmitting a non-real time communication, according to exemplary embodiments of the present disclosure. The method 500 may represent an exemplary embodiment of the scheduling transmission 434 of FIG. 4. Although the physical devices and components that form the system have largely already been described, additional details regarding their more nuanced operation will be described below with respect to FIGS. 1-4.

A communication transmission operation starts (502) when a request to transmit message is received from one of the communication devices 120 or 130 indicating that a non-real time communication is desired to be transmitted to/from a correctional facility. For example, an inmate or an outsider can open an application on the wireless communication device 124 or 136 and submit a request to transmit message after generating and saving an audio, video, photo, text, or bundled message. When the inmate or outsider indicates that the communication is ready to be sent, for example, by pressing a send button, the application server 210 receives the request to transmit message. Next, the scheduling server 204 requests, from the communication device 120 or 130, to receive data regarding the communication desired to be sent (504). The requested data includes data indicating the type and size of the communication desired to be sent. The scheduling server 204 then receives the requested data from the communication device 120 or 130 (506). In an embodiment, the scheduling server 204 can receive the data indicating the type and size of communication without transmitting the request, instead the data can be with the as the request to transmit.

At this point, the scheduling server 204 generates cost and schedule options for transmitting the communication desired to be sent (506). For example, one of the cost and schedule options includes the scheduling server 204 determining a cost of transmitting the communication at a lowest transmission cost based the size and type of communication and cost factors and scheduling factors stored by the scheduling server 204, such as transmitting the communication during network idle times and/or at a slow transmission speed. In another example, one of the cost and schedule options includes the scheduling server 204 determining a cost of transmitting the communication at a predetermined time such as the cost of transmitting the communication immediately or within an hour. In an embodiment, the scheduling server 204 transmits a request for additional input from a transmitting party, such as a preferred date and time or a date and time before which the transmitting party desires the communication to be transmitted, or a desired speed of transmission before determining the cost of transmitting the communication. For example, the scheduling server may provide an option for the transmitting party to have the non-real time communication transmitted at the lowest cost. In selecting the lowest cost, the non-real time communication would be transmitted based on one or more of factors including a reduced speed, a high compression rate, packet size, and a predicted time of low or near idle network traffic.

Once the scheduling and cost options have been generated, a scheduling message is transmitted from the scheduling server 204 to the device from which the request to transmit message was received (508). The scheduling message includes data indicating the costs and schedule options for sending the non-real time communication. Next, transmission parameters are received from the communication device 120 or 130 by the scheduling server 204 based on the cost and scheduling options selected by the transmitting party (510). The received transmission parameters, are used by the scheduling server 204 to generate scheduling data which includes the date and time of when the communication is scheduled to be transmitted and a method of transmitting the communication. For example, the scheduling data includes information to indicate that a communication should be transmitted at a least expensive time and by a least expensive method. In another example, the scheduling data includes information to indicate that a communication should be transmitted at an earliest availability and at a slowest transmission speed. In another example, the scheduling data includes specific information to indicate that a communication should be transmitted before 6 am and be transmitted with the smallest packet size.

After the scheduling data is determined, the generated non-real time communication is uploaded to the communication server 202 (5512). When received, the communication is stored by the communication server 202, and the communication center 110 is configured to allow the party to access the saved communication for editing or deletion of the communication by way of the user interface (514) until a predetermined time or event occurs. The predetermined time or event includes one or more of a start of a cutoff period prior to scheduled transmission of the communication, a start of monitoring of the communication by the monitoring center 140, or receipt of an administrator approval.

After the predetermined time and according to scheduling data, the communication is transmitted to the receiving party (516). As example, if a party, by way of the received scheduling data, indicates that the communication should be transmitted at the lowest cost possible, the communication server 202 controls the network governor and thereby regulates a transmission speed at which the communication is transmitted to the receiving party. Further, the communication server 202 can additionally transmit the communication at time of low or near idle network traffic such as between 1 am and 6 am. After the communication is transmitted to the receiving party, the communication transmission operation ends (518).

### Exemplary Computer Implementation

It will be apparent to persons skilled in the relevant art(s) that various elements and features of the present disclosure, as described herein, can be implemented in hardware using analog and/or digital circuits, in software, through the execution of computer instructions by one or more general purpose or special-purpose processors, or as a combination of hardware and software.

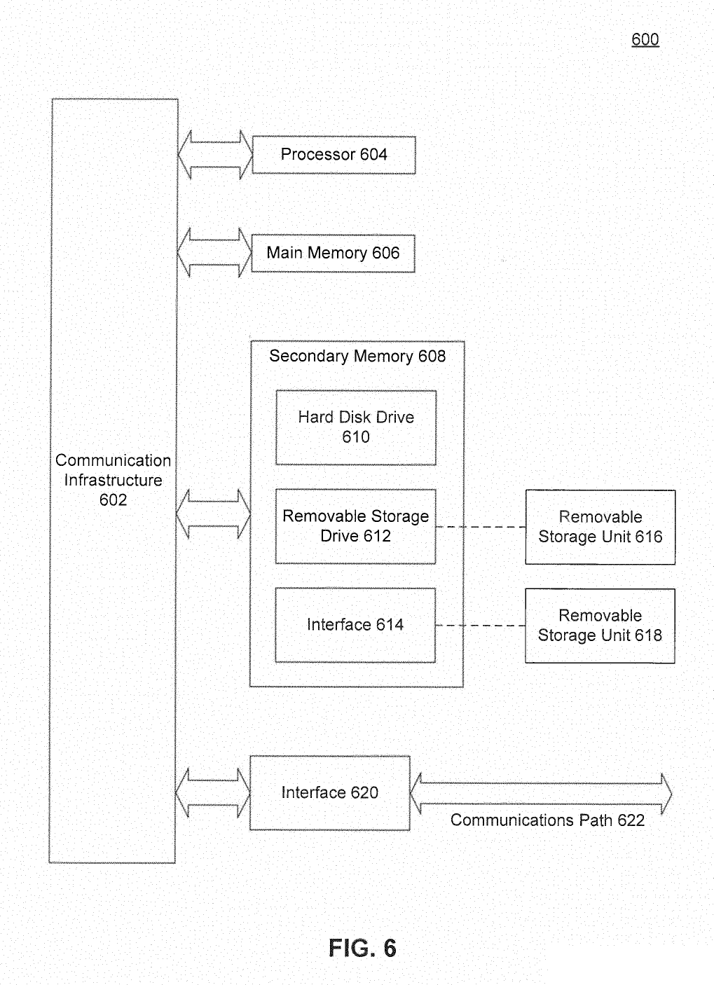

The following description of a general purpose computer system is provided for the sake of completeness. Embodiments of the present disclosure can be implemented in hardware, or as a combination of software and hardware. Consequently, embodiments of the disclosure may be implemented in the environment of a computer system or other processing system. For example, the methods of FIGS. 4 and 5 can be implemented in the environment of one or more computer systems or other processing systems. An example of such a computer system 600 is shown in FIG. 6. One or more of the modules depicted in the previous figures can be at least partially implemented on one or more distinct computer systems 600.

Computer system 600 includes one or more processors, such as processor 604. Processor 604 can be a special purpose or a general purpose digital signal processor. Processor 604 is connected to a communication infrastructure 602 (for example, a bus or network). Various software implementations are described in terms of this exemplary computer system. After reading this description, it will become apparent to a person skilled in the relevant art(s) how to implement the disclosure using other computer systems and/or computer architectures.

Computer system 600 also includes a main memory 606, preferably random access memory (RAM), and may also include a secondary memory 608. Secondary memory 608 may include, for example, a hard disk drive 610 and/or a removable storage drive 612, representing a floppy disk drive, a magnetic tape drive, an optical disk drive, or the like. Removable storage drive 612 reads from and/or writes to a removable storage unit 616 in a well-known manner. Removable storage unit 616 represents a floppy disk, magnetic tape, optical disk, or the like, which is read by and written to by removable storage drive 612. As will be appreciated by persons skilled in the relevant art(s), removable storage unit 616 includes a computer usable storage medium having stored therein computer software and/or data.

In alternative implementations, secondary memory 608 may include other similar means for allowing computer programs or other instructions to be loaded into computer system 600. Such means may include, for example, a removable storage unit 618 and an interface 614. Examples of such means may include a program cartridge and cartridge interface (such as that found in video game devices), a removable memory chip (such as an EPROM, or PROM) and associated socket, a thumb drive and USB port, and other removable storage units 618 and interfaces 614 which allow software and data to be transferred from removable storage unit 618 to computer system 600.

Computer system 600 may also include a communications interface 620. Communications interface 620 allows software and data to be transferred between computer system 600 and external devices. Examples of communications interface 620 may include a modem, a network interface (such as an Ethernet card), a communications port, a PCMCIA slot and card, etc. Software and data transferred via communications interface 620 are in the form of signals which may be electronic, electromagnetic, optical, or other signals capable of being received by communications interface 620. These signals are provided to communications interface 620 via a communications path 622. Communications path 622 carries signals and may be implemented using wire or cable, fiber optics, a phone line, a cellular phone link, an RF link and other communications channels.

As used herein, the terms “computer program medium” and “computer readable medium” are used to generally refer to tangible storage media such as removable storage units 616 and 618 or a hard disk installed in hard disk drive 610. These computer program products are means for providing software to computer system 600.

Computer programs (also called computer control logic) are stored in main memory 606 and/or secondary memory 608. Computer programs may also be received via communications interface 620. Such computer programs, when executed, enable the computer system 600 to implement the present disclosure as discussed herein. In particular, the computer programs, when executed, enable processor 604 to implement the processes of the present disclosure, such as any of the methods described herein. Accordingly, such computer programs represent controllers of the computer system 600. Where the disclosure is implemented using software, the software may be stored in a computer program product and loaded into computer system 600 using removable storage drive 612, interface 614, or communications interface 620.

In another embodiment, features of the disclosure are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

### CONCLUSION

It is to be appreciated that the Detailed Description section, and not the Abstract section, is intended to be used to interpret the claims. The Abstract section may set forth one or more, but not all exemplary embodiments, and thus, is not intended to limit the disclosure and the appended claims in any way.

The invention has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) that various changes in form and detail can be made therein without departing from the spirit and scope of the disclosure. Thus, the invention should not be limited by any of the above-described exemplary embodiments, but should be defined only in accordance with the following claims and their equivalents.

What is claimed is:

1. A non-real time communication system for transmitting a non-real time communication to or from a correctional facility, the non-real time communication system comprising:
an interface subsystem that includes:
an interface unit that is configured to facilitate a user in generating a non-real time communication;
a memory that stores the non-real time communication; and
a scheduling subsystem that includes:
a scheduling database that stores scheduling data for transmitting non-real time communications; and
a scheduling server configured to transmit the non-real time communication based on the scheduling data.

2. The non-real time communication system of claim 1, wherein the non-real time communication is one or more of a text message, an audio message, a video message, a photo, or a bundled message.

3. The non-real time communication system of claim 1, wherein the scheduling subsystem generates the scheduling data based on data indicating a time when a network traffic is predicted to be near idle.

4. The non-real time communication system of claim 1, further comprising a communication server configured to control at least one or more of a transmission quality, a transmission speed, or a transmission packet size of the non-real time communication.

5. The non-real time communication system of claim 4, wherein the scheduling subsystem generates the scheduling data based on data received from the user interface indicating a user's selection on at least one of the transmission quality, the transmission speed, or the transmission packet size for transmitting the non-real time communication.

6. The non-real time communication system of claim 5, wherein the interface unit is further configured to facilitate retrieval of the non-real time communication from the storage subsystem for editing prior to the determined date and time.

7. The non-real time communication system of claim 6, wherein the user interface is further configured to retrieve the non-real time communication from the storage subsystem until a predetermined event occurs.

8. The non-real time communication system of claim 7, wherein the predetermined event includes one or more of a start of a cutoff period prior to a scheduled transmission of the non-real time communication, a start of monitoring of the non-real time communication by a monitoring center, or receipt of an administrator approval.

9. The non-real time communication system of claim 1, wherein the scheduling data indicates a time and a method of transmitting the non-real time communication.

10. A scheduling server for scheduling a transmission of a non-real time communication to or from a correctional facility, the scheduling server comprising:
a network interface device configured to communicate with a communication device over a network; and
at least one processor configured to:
receive a request to transmit message from a communication device indicating that a non-real time communication is ready to be transmitted;
transmit, to the communication device, a scheduling message including cost options for sending the non-real time communication;
receive, from the communication device, selected transmission parameters; and
generate scheduling data indicating a time for transmitting the non-real time communication based on the selected transmission parameters.

11. The scheduling server of claim 10, wherein the selected transmission parameters include data indicating at least one of a transmission quality, a transmission speed, or a transmission packet size for transmitting the non-real time communication.

12. The scheduling server of claim 12, wherein the transmission quality includes a compression rate for transmitting the non-real time communication.

13. The scheduling server of claim 10, wherein the scheduling data is further based on data indicating whether a monitoring of the non-real time communication or an administrator approval is required prior to transmitting the non-real time communication.

14. The scheduling server of claim 10, wherein the at least one processor is configured to determine the cost options for transmitting the non-real time communication based on a predicted amount of traffic on the network.

15. The scheduling server of claim 10, wherein the at least one processor is configured to determine the cost options for transmitting the non-real time communication based on a lowest cost and slowest transmission method during a predetermined time period.

16. A communication server for transmitting a non-real time communication to or from a correctional facility, the communication server comprising:
a network interface device configured to communicate with a communication device over a network;
a storage device that stores non-real time communications; and
at least one processor configured to:
receive scheduling data that indicates a time and method of transmitting a non-real time communication; and
transmit the non-real time communication based on the scheduling data.

17. The communication server of claim 16, wherein the at least one processor is further configured to control a network governor to adjust a transmission speed when transmitting the non-real time communication based on the scheduling data.

18. The communication server of claim 16, wherein the at least one processor is further configured to compress, prior to transmission, the non-real time communication based on the scheduling data.

19. The communication server of claim 16, wherein the at least one processor is further configured to allow access to the non-real time communications for editing or deletion until a predetermined event occurs.

20. The communication server of claim 19, wherein the predetermined event includes one or more of a start of a cutoff period prior to a scheduled transmission of the non-real time communication, a start of monitoring of the non-real time communication by a monitoring center, or receipt of an administrator approval.
